(19) United States
(12) Patent Application Publication
(10) Pub. No.: US 2010/0033349 A1
(43) Pub. Date: Feb. 11, 2010

(54) System and method for railway vehicle detection

(76) Inventors: Kim-Fung TSANG, Hong Kong (CN); Lap To Lee, Hong Kong (CN)

Correspondence Address: Kim-Fung Tsang, EE 83 Tat Chee Avenne, Kowloon Tong, Hong Kong, CN

(21) Appl. No.: 12/188,364

(22) Filed: Aug. 8, 2008

(51) Int. Cl. G08G 1/01; H04Q 5/22

(52) U.S. Cl. 340/935; 340/10.1

(57) ABSTRACT

A system and method for detecting the railway vehicle with a plurality of RFID readers and tags are disclosed. Railway vehicle directional movement on specific track can be detected and updated by the RF communication of the readers and tags. The railway system also includes a computer which monitors a couple of RFID readers for the real-time railway vehicle position. Intelligent detection algorithm is implemented in the reader to identify specific railway vehicle, on a particular track for at least one track in bidirectional or parallel direction. For encoding the data, each RF tag is of unique ID and the RF signal is encrypted.

### FIELD OF THE INVENTION

The present invention relates generally to the field of railway vehicle detection system, and in particular to a method for arrival and departure detection of the said railway vehicle at railway platform with a plurality of readers and tags over the track.

### BACKGROUND OF THE INVENTION

Railway detection in a railway system facilitates the operation of the monitoring of the railway vehicles. Identification of the railway vehicles is the first step to report accurate railway schedule to satisfy passengers. Nowadays, the railway system is extended to a nationwide coverage in which millions of passengers are travelling annually. A systematic approach is needed to report railway schedule especially when accident is happened. A prompt and accurate delay notice announced to the passengers is urgently needed to compensate customers for the postponement.

As for the railway system, the complexity is another issue causing monitoring and controlling difficulties. Various environmental and railway connections are making the detection and identification process a difficult task. The tracks are typically comprised of two rails in either bidirectional or parallel direction of movement. These characteristics contribute the key reason for the detection predicament.

It is therefore recommended and desirable to implement a systematic approach and method for detecting a specific railway vehicle, a specific direction and a precise location, especially when the railway vehicle is approaching or departing a station.

### BRIEF SUMMARY OF THE INVENTION

The present invention is directed to at least one pair of RFID reader and active RFID tag for detecting the position and track section of the railway vehicle. In particular, the tag attached on the railway vehicle communicates with the reader installed on the track which precisely updates the arrival and departure schedule. Further, special identification of the railway vehicle on parallel and bidirectional track are focused to report specific railway vehicle. A central computing unit is also served to collect real time arrival and departure information from readers to facilitate the operation of railway system.

### BRIEF DESCRIPTION OF THE DRAWINGS

FIG. 1A shows a top perspective view of RFID reader;

FIG. 1B shows a front perspective view of RFID reader;

FIG. 1C shows a side perspective view of RFID reader;

FIG. 1D shows a side perspective view of active RFID tag;

FIG. 1E shows a front perspective view of active RFID tag;

FIG. 1F shows a bottom perspective view of active RFID tag;

FIG. 2 shows a schematic illustration of the installation of RFID reader and active RFID tag on a railway system.

FIG. 3 shows a schematic illustration of the railway system;

FIG. 4 shows a timing diagram of the RFID tag identification transmission;

FIG. 5 shows a communication flow diagram of the present invention;

FIG. 6 shows a graphical representation of the link quality indicator LQI of the signal strength;

FIG. 7 shows a flow chart depicting the detection and reporting process of the railway vehicle by reader;

FIG. 8 shows a flow chart depicting the arrival logic of the reader;

FIG. 9 shows a flow chart depicting the departure logic of the reader;

FIG. 10 shows a schematic illustration of the detection logic executed in the central computing unit.

### DETAILED DESCRIPTION

The following detailed description of present embodiments refers to the accompanying drawings, which illustrate specific embodiments of the invention. Other embodiments having different structures and operations do not depart from the scope of the present invention. The embodiments described herein are also susceptible to variations, modifications and/or additions other than those specifically described and it is to be understood that the invention includes all such variations, modifications and additions which fall within the spirit and scope of the above description.

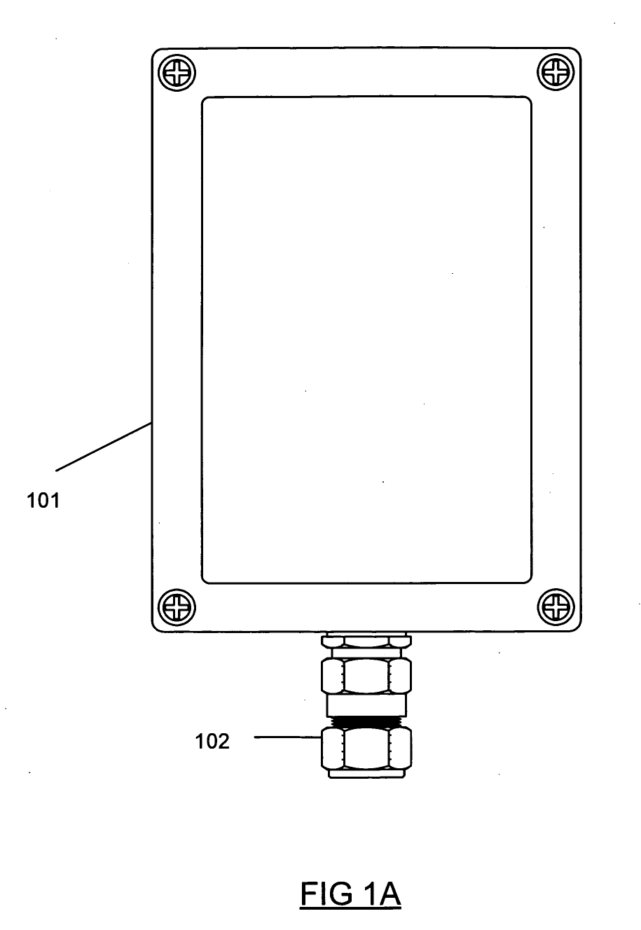

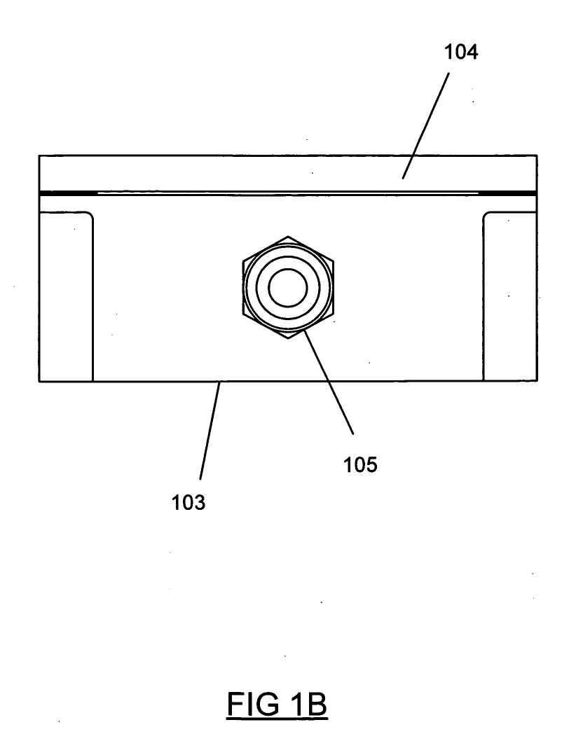

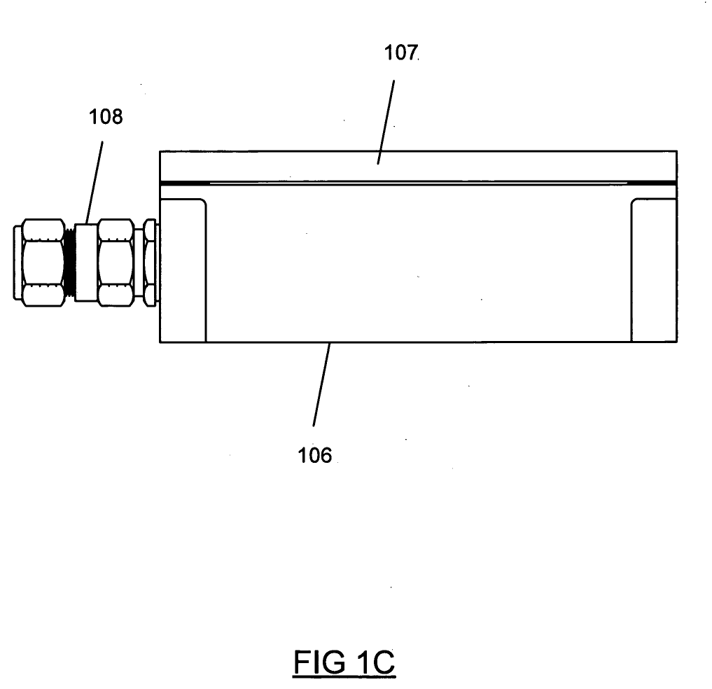

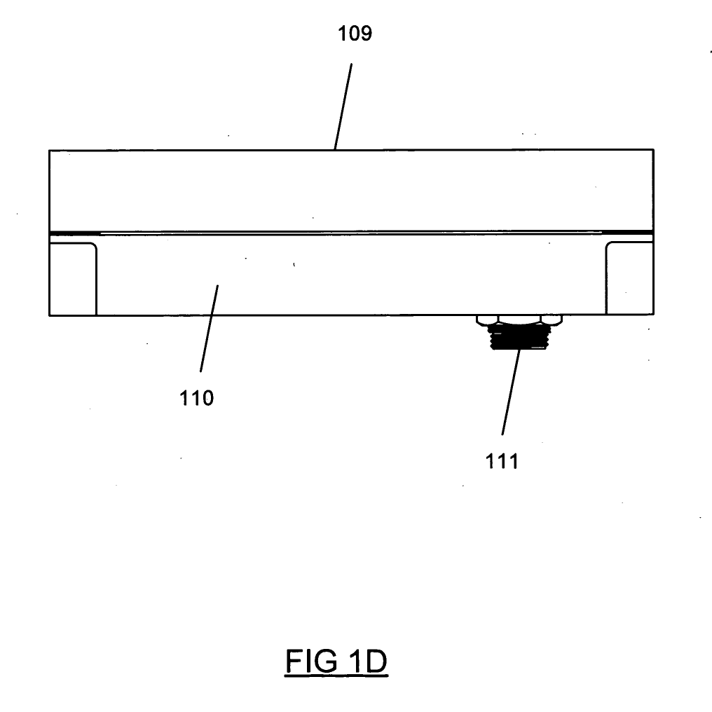

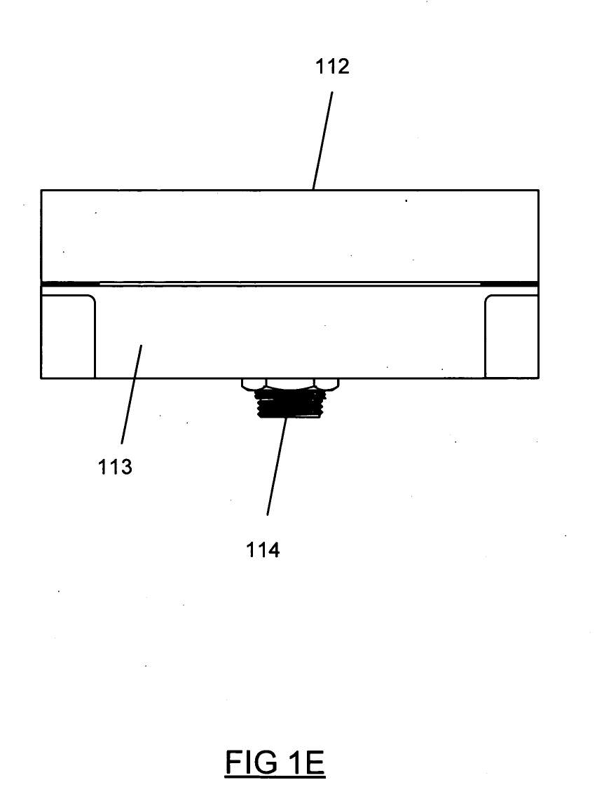

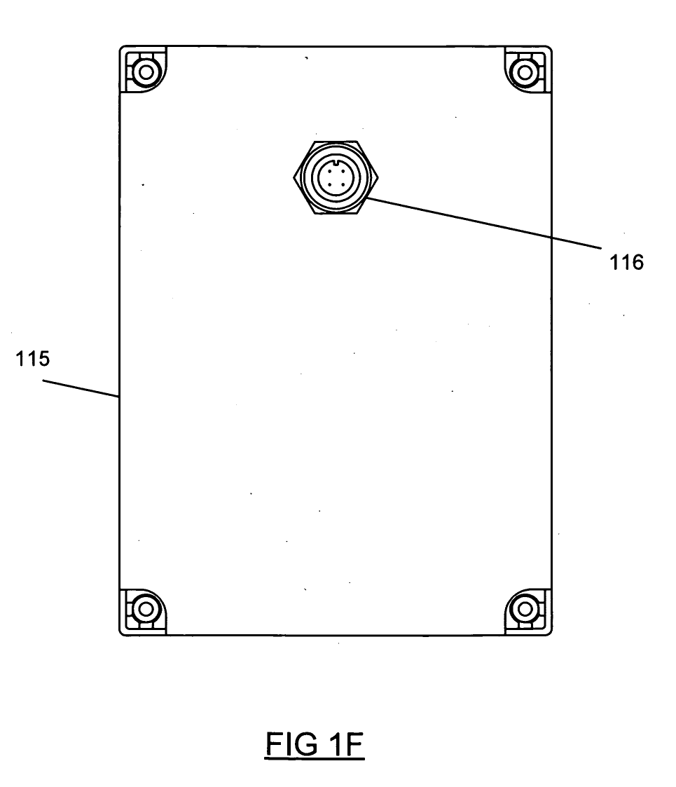

Present invention related to the railway vehicle system in which a pair of active RFID (Radio Frequency Identification) reader and tag provides the detection of the railway vehicle. The reader is mounted on the tracks way sleeper or inside the track way drawpit and the tag is mounted underneath the railway vehicle. As illustrated in FIG. 1A, a top perspective view of the RFID reader is provided. The reader case 101 comprises upper and lower part where four screws are tightened at the corner positions to screw up the case and provide IP67 ingress protection. To operate the reader, power supply and data communication with central computing unit are integrated with two pairs of cable, which are a twisted pair RS-485 cable and a pair of DC power supply cable, within an armour cable. The armour gland 102 provides IP67 ingress protection allowing the reader to be installed at adverse environment.

FIG. 1B illustrates a front perspective view of the reader. The lower part 103 and upper part 104 of the case can be shown in the front view. Further, the armour gland 105 placed in front represents the direction of the installation of the reader on the track.

FIG. 1C illustrates a side perspective view of the reader. Likewise, the side view does not depart from the aforementioned description as the lower part 106, upper part 107 and armour gland 108 are shown in this figure.

FIG. 1D illustrates a side perspective view of the active RFID tag. In the preferred embodiment, the tag is mounted underneath at the front of the railway vehicle to facilitate signal transmission. Similar to the RFID reader, the tag comprises an upper case 109 and a lower case 110 in the same way and case of tag provides IP67 ingress protection. An IP67 ingress protection connector 111 is implemented at the bottom of the tag. A pair of power supply cable is plugged in the connector 111 for power supply. The vehicle identity transmitted from the tag is encrypted to enhance security.

FIG. 1E illustrates a front perspective view of the tag. Likewise, the front view does not depart from the aforementioned description as the upper case 112, lower case 113 and IP67 ingress protection connector 114 are shown in this figure.

FIG. 1F illustrates a bottom perspective view of the tag. As shown in the figure, the IP67 ingress protection connector 116 is located underneath of the tag for the power supply purpose.

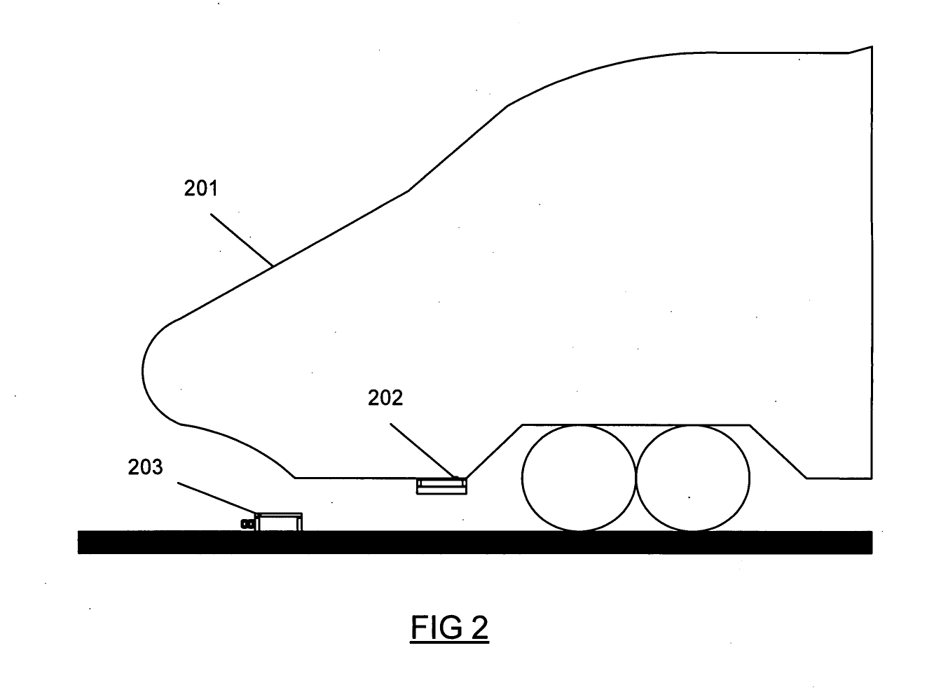

FIG. 2 is a schematic illustration of the installation of RFID tag and reader. A preferred installation is shown in the front part of the railway vehicle 201 where the tag 202 is mounted underneath for shortening the distance of signal transmission. The reader 203 is located on the track in coordination with the tag position.

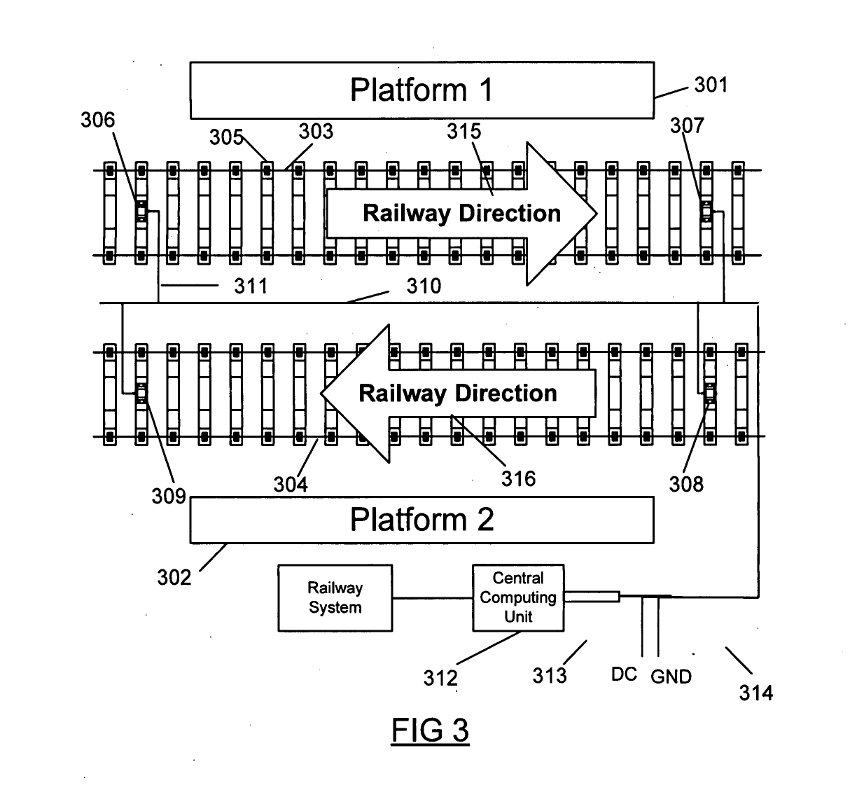

FIG. 3 is a system overview according to the present invention. A track section comprising two platforms 301, 302 are demonstrated for the scenario of intermediary station where the railway directions are in opposing direction 315, 316. In real railway system, curvature of track section, railway direction, platform location and track structure are subjected to variations or modifications according to the environment. The present invention can also be applied to any track section in the railway system. The RFID readers 306, 307, 308, 309 are powered by DC power supply 313 and ground 314. In particular, the readers 306, 307, 308, 309 can be characterized as an arrival and/or a departure reader. The assignment of the pair of arrival and departure readers depends upon the railway direction. In the preferred scenario, readers 306 and 308 are named to be the arrival readers while readers 307 and 309 are named to be the departure readers. For every track, a pair of arrival and departure readers is installed where the arrival readers 306, 308 are placed in front of the corresponding platform and the departure readers 307, 309 are placed at the end of the corresponding platform.

For example, when the railway vehicle arrives at platform 1 301, the RFID signal from the tag on the said vehicle can be received by the arrival reader 306 in which a unique identity for each railway vehicle is recorded in the signal. After the reader 306 receives the polling message from the central computing unit 312, the reader 306 replies the central computing unit 312 with the arrived vehicle identity through the RS-485 cables. Likewise, when the railway vehicle departs from platform 1 301, the reader 307 replies central computing unit 312 with the departed vehicle identity. It is noted that the RS-485 cable and DC power supply cable 314, 315 are embedded in a 4-wire armour cable 311 in the aforementioned description. Along the bidirectional track section, a couple of arrival and departure readers 306, 307, 308, 309 are connected as a network by a bus topology 310 wherein the data communication and power supply are transmitted over the network. A T-join is illustrated in the bus topology 310 in the current scenario.

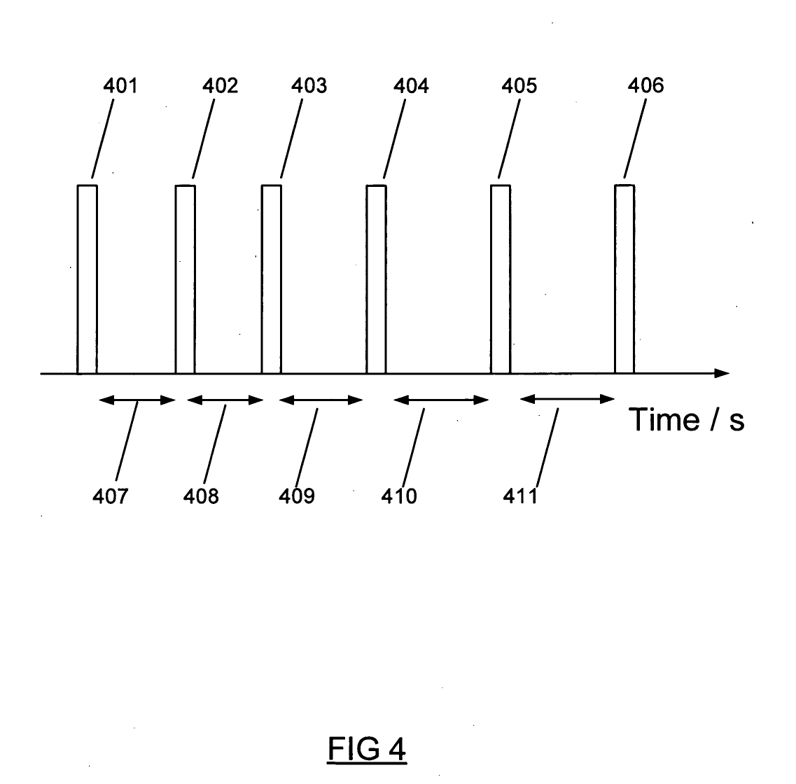

FIG. 4 is a timing diagram of the identification signal from the active RFID tag. The peak 401-406 represents the transmission of identification signal wherein the period of the identification signal is relatively short. In the current example, the period is estimated to be around 2 ms. In the timing diagram, it is shown that the identification signal transmits repeatedly and periodically after a delay of 80-110 ms as an example. During the delay, the signal transmission is suspended after the signal transmission. For every delay, the period is randomized within the range of 80-110 ms so as to avoid interference in the proximity of the tag signal, whereby every other delay 407-411 varies slightly as shown in the current example. This type of signal generation is best adapted to at least one track in either bidirectional or parallel direction.

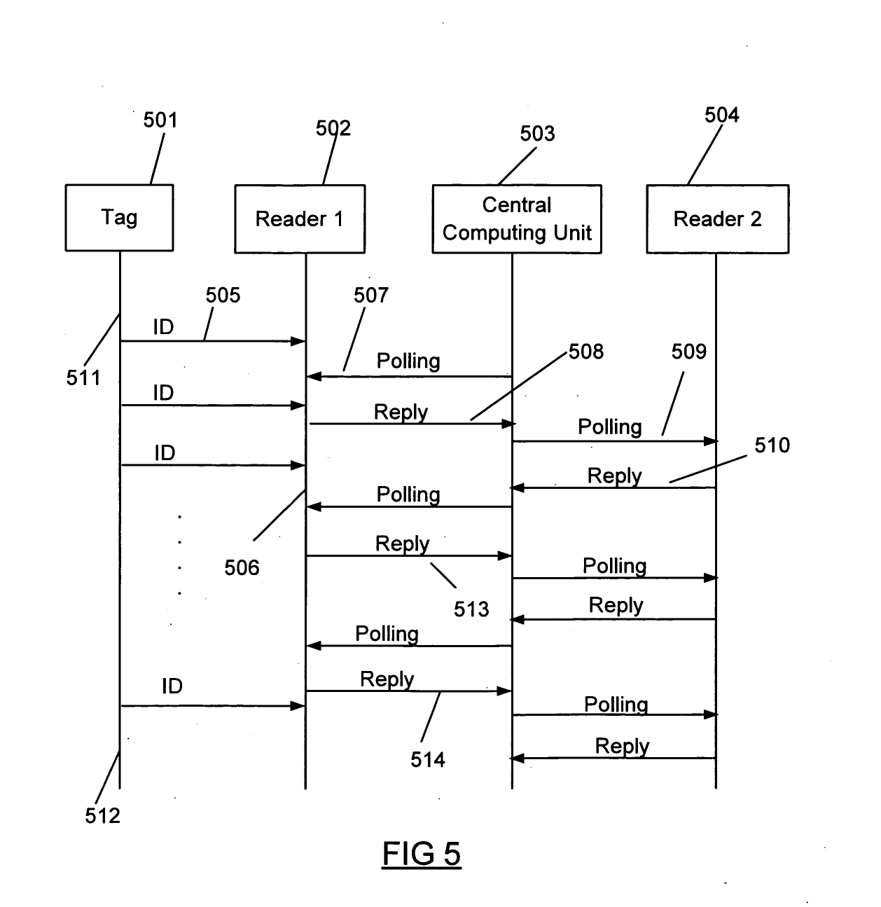

FIG. 5 is a communication flow of the railway system. The railway system comprises active RFID tag on the railway vehicle 501, RFID readers on the track 502, 504 and central computing unit 503. As a preferred example, the diagram depicts how system devices communicate within the railway system. As an example, reader 1 502 acts as an arrival reader while reader 2 504 acts as a departure reader. When a railway vehicle is approaching 511 the arrival reader 502, the tag 501 broadcasts identification signals 505 periodically and repeatedly in the wireless RF medium. Whenever the reader 1 502 receive the identification signals 505, the reader 502 processes the signal in identifying the tag identify, link quality (signal strength) and the time of reception in an arrival list. A new list is constructed as a railway vehicle is detected wherein the attributes are stored and processed in the list. Once the attributes meet the requirement of arrival, an arrival message 513 will be created in a message buffer.

On the other hand, the central computing unit 503 polls arrival or departure request to the reader by the RS-485 network. A reply 508 will be responded with a message to the central computing unit 503. In normal occasion, the reply 508 is usually reporting no vehicle approaching. Once the railway vehicle is proved to be approaching 506, the said arrival message 513 will be replied to the central computing unit 503. Afterwards, the reply message 514 resumes to report no railway vehicle is approaching.

As for the central computing unit 503, the departure reader 504 should receive polling message in the RS-485 network as the central computing unit 503 polls every reader in the network. In this preferred example, the reader 504 does not receive any identification signal 505 from the tag 501 thus reporting no railway vehicle is departing.

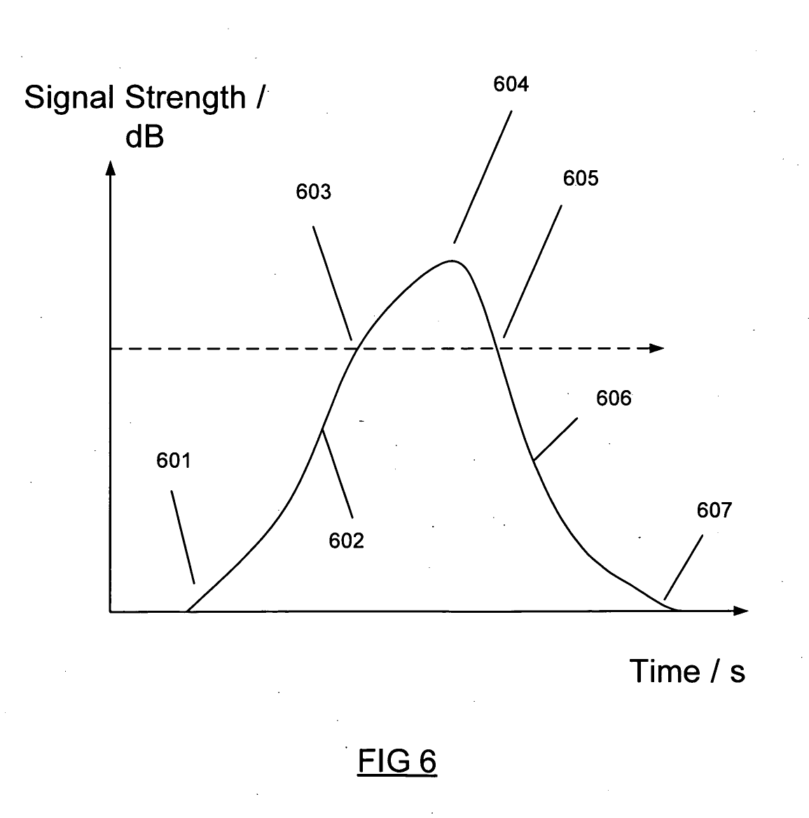

FIG. 6 is a graphical representation of the link quality (signal strength) received in the RFID reader. In the aforementioned description, the said tag transmits signals repeatedly along the track. As for the reader, the link quality received varies as the railway vehicle moves. When the railway vehicle is approaching the reader, the receiver of the reader starts detecting the signal 601. The link quality increases exponentially 602 as the railway vehicle continuously travels along the reader track section. When the tag of railway vehicle is just past the reader, a peak link quality 604 is expected representing the railway vehicle is located at the reader. In the preferred embodiment, it is noted that the link quality drops drastically 606 when the railway vehicle is beyond the reader. Signal fading due to the interference by machinery in the bottom part of the railway vehicle whereby metallic absorption accounts for the rationale behind this significant drop. As a result, the graphical representation shows an unsymmetrical curve. Consequently, the link quality disappears 607 as the railway vehicle is out of the detection range.

The characteristics of the arrival and departure readers differentiate with the trigger level setting. For arrival reader, a preferred trigger level 603 of link quality is preset prior to the peak 604 indicating the railway vehicle is meters within the reader. For departure reader, the preferred trigger level 605 is preset beyond the peak 604 indicating the railway vehicle is meters away from the reader.

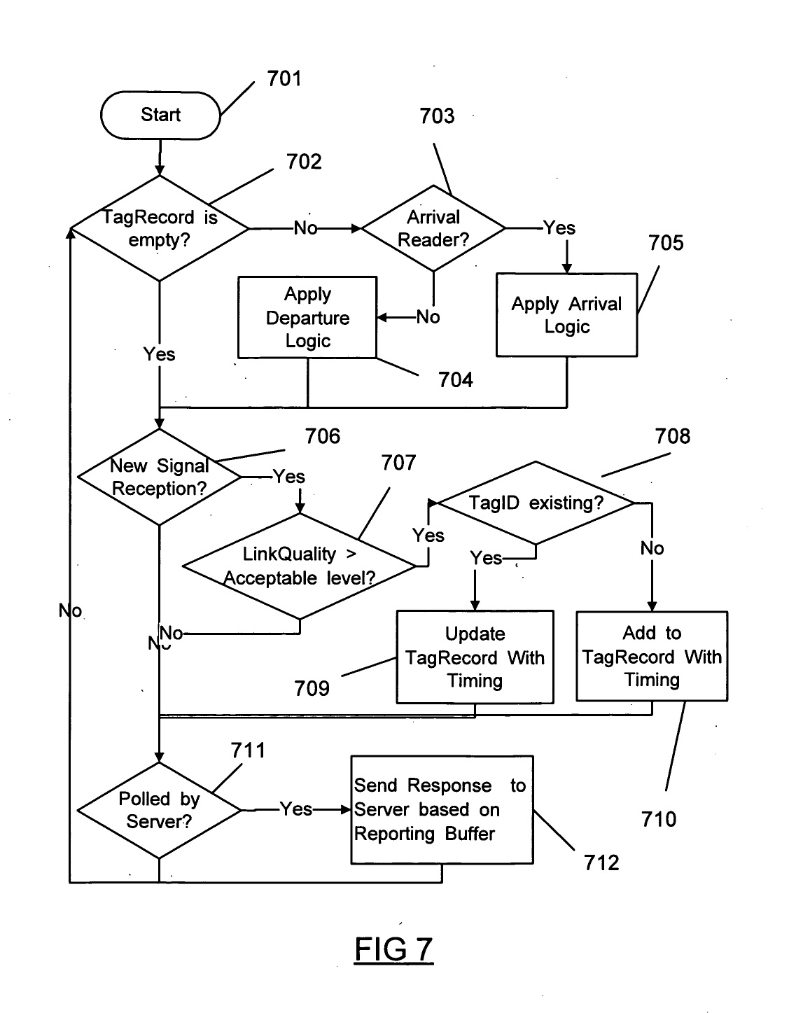

FIG. 7 is a detailed flow chart representation of the reader. Generally speaking, the reader handles three functions repeatedly: Logical decision, signal processing and polling response.

The reader starts 701 and checks the tag record in the first process. As for operating the logical decision of arrival or departure, tag record has to be ensured 702 before logical operation. Then, an identification of arrival or departure nature 703 is processed before applying arrival 704 or departure 705 logic respectively.

Afterwards, the RF receiver listens to the identification signal 706. If a signal is received in which the link quality (signal strength) is above an acceptable level 707, the tag ID is extracted from the signal to check whether the tag ID is existed 708. The accepted level stated can be set by the railway system administrator. An update of tag record with timing 709 is performed for an existing tag ID while a new addition of tag record with timing 710 is performed for a new tag ID.

On the other hand, the central computing unit polls periodically to the reader. The reader listens to the polling message 711 and responds to the central computing unit computer based on the reporting buffer 712. The reader loops these three functions repeatedly achieving the detection and reporting purposes.

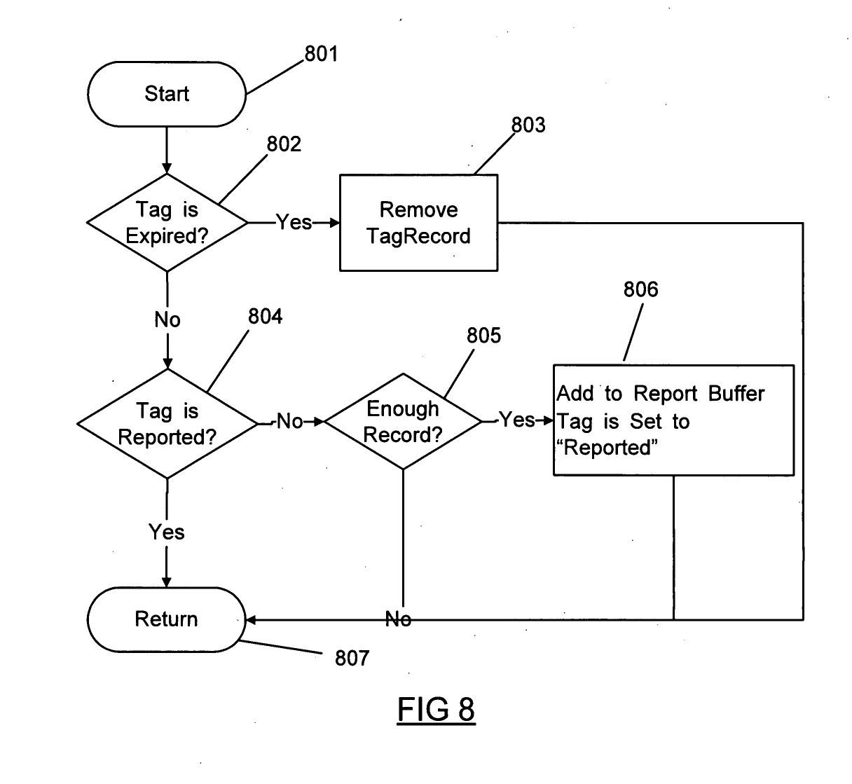

FIG. 8 is a flow chart representation of the arrival reporting logic where the logic comprises a few checking processes. The arrival logic begins 801 by checking whether the tag has been expired 802 since an expired tag record has to be removed 803. After a period of time which can be set by railway administrator, the tag is considered as expired if no other tag record is received. If the tag is not expired, a flag indicating whether the tag has been reported is checked 804 to ensure the tag record does not add to the buffer. The checking is to guarantee one and only one report is allowed for a tag record. Once reported, the arrival logic processes will be skipped and returned to the operation of the reader 807. If the tag record is not reported, the list of the tag record is to be examined if there are enough records 805 representing an arrival message to be set in the report buffer 806. In this process, an arrival list storing the tag records for specific tag ID is examined.

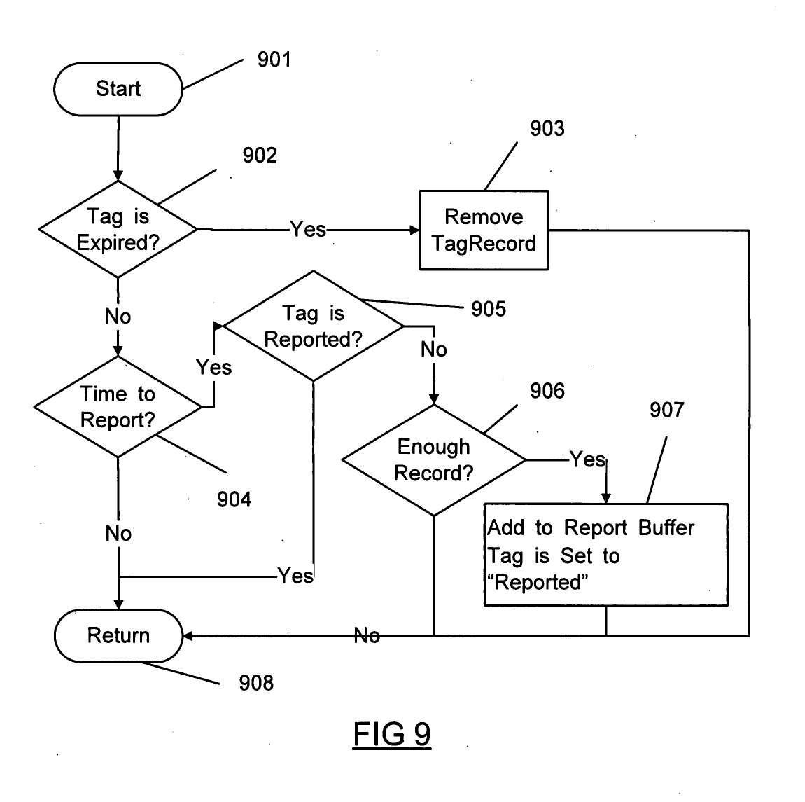

FIG. 9 is a flow chart representation of the departure reporting logic where the departure logic is similar to the arrival logic. The departure logic begins 901 by checking whether the tag has been expired 902 since an expired tag record has to be removed 903. After a period of time which can be set by railway administrator, the tag is considered as expired if no other tag record is received. If the tag is not expired, a special reporting timing is applied to check whether it is the right time to report. The reporting sequence for departure is designed to identify the railway vehicle has past the reader for a period of time. Similarly, when it is the time to report, a flag indicating whether the tag has been reported is checked 905 to ensure the tag record does not add to the buffer. The checking is to guarantee one and only one report is allowed for a tag record. Once reported, the departure logic processes will be skipped and returned to the operation of the reader 908. If the tag record is not reported, the list of the tag record is to be examined if there are enough records 906 representing a departure message to be set in the report buffer 907. In this process, a departure list storing the tag records for specific tag ID is examined.

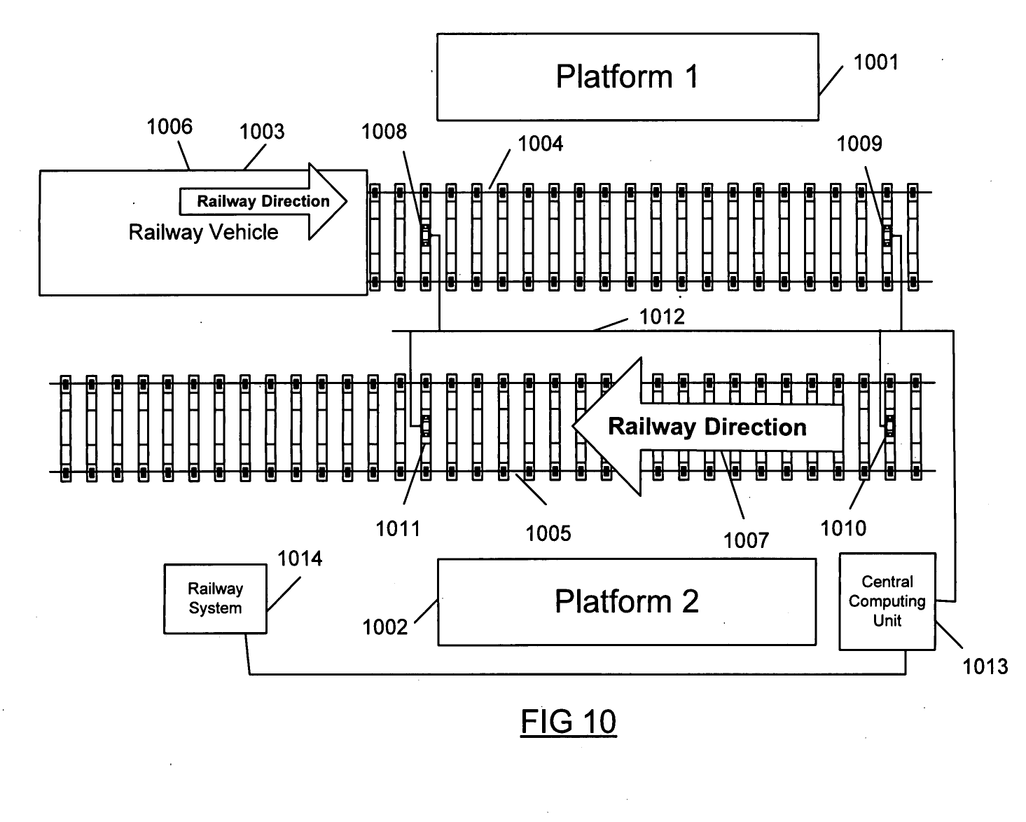

After the readers have detected and reported to the central computing unit, two approaches are supported by the central computing unit to report the position of the vehicle to the railway system, which can be done by either direct reporting or associated reporting approach. FIG. 10 is a preferred scenario showing two approaches for an example of bidirectional intermediate station in the central computing unit. The approaches also apply to other stations where parallel tracks are present in the terminus or other scenarios. The object is to identify specific railway vehicle with direction on recognizable track sections in proximity. In this preferred scenario, a railway vehicle 1003 is approaching the station in the direction as shown 1006 where a couple of readers 1008-1011 are located at platform 1 and 2 1001, 1002 accordingly. Likewise, readers 1008, 1010 are named as arrival readers and readers 1009, 1011 are named as departure reader.

In direct reporting approach, the tag mounted underneath the railway vehicle 1003 broadcasts RF signal periodically. Both arrival reader 1008 and departure reader 1011 are capable of receiving the RF signal. A dilemma of which reader collects the respective railway vehicle signal on the respective track is to be analyzed. As the readers 1008, 1011 clearly identify the unique ID of the railway vehicle 1003, the data reported to the railway system 1014 should be able to spot these unreasonable reports wherein both tracks report the same tag signal at the same time. Therefore, systematic railway system 1014 determines the arrival reader 1008 is receiving the arrival signal according to railway schedule while the departure reader 1011 receiving the departure signal is not true indeed.

In the associated reporting approach, the aforementioned dilemma can also be solved by the preferred detection logic in the central computing unit 1013. On the same preferred scenario, the central computing unit 1013 first polls the arrival reader 1010 to check whether any railway vehicle has been arrived at platform 2 1002 on track 1005. The rationale behind this polling analysis is that when there is a departure, there must be an assumed prior arrival within a reasonable time period. It is be understood that if reader 1010 did not report arrival, then the RF signal received in departure reader 1011 must be from alternative track section. The arrival reader 1008 is receiving the correct signal. Therefore, vehicle identity detected by reader 1008 will be reported to the railway system 1014.

If the arrival reader 1010 did report prior arrival, it is understood that the RF signal received in departure reader 1011 is receiving the corresponding departure and the arrival reader 1008 is reporting fault indeed.

What is claimed is:

1. A method of detecting specific railway vehicle directional movement on a track section of a railway system, wherein a plurality of RFID readers are mounted on track and active RFID tags are mounted on the railway vehicles, and at least one central computing units for monitoring the network of readers, said method comprising:
analyzing the link quality indicator (signal strength) received in the said reader determining the reception of tag identification signal;
reporting the arrival or departure nature of the said reader with the railway vehicle detection results to the central computing unit;
distinguishing the correct tag signal received from a couple of readers on a couple of tracks in proximity to identify specific railway vehicle.

2. The method of claim 1, wherein the said reader can be considered as either arrival or departure nature interchangeably.

3. The method of claim 1, wherein the said tag transmits identification signal periodically with a randomized delay period.

4. The method of claim 1, wherein a trigger level can be set in the said link quality indicator as an indication of arrival or departure reporting.

5. The method of claim 4, wherein the arrival reader reports successful detection once the trigger level of the link quality indicator is first reached.

6. The method of claim 4, wherein the departure reader reports successful detection after the link quality indicator drops below the trigger level on condition that the link quality indicator has surpassed the trigger level.

7. The method of claim 1, wherein the said reporting arrival or departure detection from the said reader is to be reported once only for each railway vehicle within a period of time.

8. The method of claim 1, wherein a detection logic is used to identify a specific railway vehicle approaching a network of readers and an analysis of polling results to spot reasonable arrival and departure logic.

9. The method of claim 8, wherein a prior arrival reporting is assumed to be reported before a departure reporting establishes.

10. A railway system, comprising:
a plurality of active RFID tags for transmitting signal storing the unique identity number of the said railway vehicle wherein the said signal is transmitted periodically and continuously;
a plurality of RFID readers for receiving the said tag signal wherein the said identity number, link quality of the signal and the time of reception are stored in a list;
at least one central computing unit for execution of the detection logic for the associated readers and reporting of the said logic to the railway system;

11. The said active RFID tag signal of claim 10, wherein encryption method is processed before transmitting the said signal.

12. The railway system of claim 10, wherein the said reader can be mounted on the tracks way sleeper or inside the track way drawpit.

13. The railway system of claim 10, wherein the said tag can be mounted underneath the railway vehicle.
